(19) United States
(12) Patent Application Publication
(10) Pub. No.: US 2004/0176942 A1
(43) Pub. Date: Sep. 9, 2004

(54) Method, system and program product for behavioral simulation(s) of a network adapter within a computing node or across multiple nodes of a distributed computing environment

(75) Inventors: George A. Chochia, Wappingers Falls, NY (US); Kevin J. Reilly, Poughkeepsie, NY (US); Paul D. DiNicola, Hurley, NY (US); Wen C. Chen, Rhinebeck, NY (US); Patricia E. Heywood, Hopewell Junction, NY (US)

Correspondence Address: HESLIN ROTHENBERG FARLEY & MESITI PC, 5 COLUMBIA CIRCLE, ALBANY, NY, 12203, US

(73) Assignee: International Business Machines Corporation, Armonk, NY

(21) Appl. No.: 10/379,024

(22) Filed: Mar. 4, 2003

(51) Int. Cl. G06F 9/45

(52) U.S. Cl. 703/22

(57) ABSTRACT

Method, system and program product are provided for simulation of a network adapter for a computing unit of a computing environment. The simulation includes providing a behavioral simulation of the network adapter and mapping the behavioral simulation to system memory of the computing unit to allow for direct memory access. Through the mapping, a network adapter function issued by a user application process of the computing unit is transparently redirected to the behavioral simulation of the network adapter, to thereby invoke a desired functional behavior. Multiple instances of the behavioral simulation of the network adapter can be employed within a single computing unit, and/or can be employed across multiple computing units of the computing environment.

### TECHNICAL FIELD

This invention relates in general to data processing systems, and more particularly, to techniques for behavioral simulation of a network adapter of a computing unit which provides a virtualization of communications, replacing physical level communications of the network adapter with a software interface to transparently support user and kernel level jobs. Further, this invention relates to techniques for behavioral simulation of a network adapter which are scalable to multiple instances of the behavioral simulation within a single computing unit and to multiple instances of the behavioral simulation of the network adapter disposed across multiple computing units of a distributed computing environment.

### BACKGROUND OF THE INVENTION

Data transfer between the processor of a host system (i.e., computing unit) and an external data processing device is performed via an input/output attachment such as a network adapter under direct control of a program being run by the host processor. Conventionally, each byte or word of data requires the execution of several instructions to transfer the data. However, certain network adapters require higher data transfer rates than are achievable with this technique. For such devices, the network adapter may use a data transfer process known as direct memory access (DMA). DMA allows the direct transfer of data between the host processor memory and the network adapter without the necessity of executing instructions in the host processor. During DMA, the host processor first initializes DMA controller circuitry by storing an account and a starting memory address in its registers. When started, DMA proceeds without further host processor intervention (except that an interrupt may be generated upon completion of the DMA operation), and hence data transmission is handled without the need to execute further instructions by the host processor.

While communication software for DMA primarily comprises the protocols, the communication hardware at the host primarily comprises the network adapter and the interface between the host and the adapter. The design of the network adapter, and the division of functionality between the adapter and the host communication software, can have a significant impact on performance delivered to applications. In order to design network adapters that integrate well with the host communication software and deliver good performance, the impact of various design parameters should be studied in a realistic setting, i.e., typically when the network adapter is controlled and accessed by the communication software on the target host platform. The performance evaluation methodology employed must consider the hardware components and overheads involved (such as the system I/O bus, caches, device interrupts), and capture the hardware-software concurrency and dynamic host-adapter interaction without excessive intrusion. This conventionally means that simulation of an application, and particularly large scale applications within a distributed environment, require the existence of the network adapter hardware in order to verify a new protocol stack. This can delay verification of the protocol stack and increase the overall development time of a system.

Thus, a need exists in the art for a behavioral simulation of a network adapter under development which allows for verification of a new protocol stack to proceed without the actual network adapter hardware, and more particularly, for a behavioral simulation of a network adapter which is scalable both within a computing unit and across multiple computing units of a distributed processing system.

### SUMMARY OF THE INVENTION

The shortcomings of the prior art are overcome and additional advantages are provided through the provision of a method for simulating a network adapter including: providing a behavioral simulation of the network adapter for a computing unit of a computing environment; and mapping the behavioral simulation to system memory of the computing unit to allow for direct memory access, the mapping being such that a network adapter function issued by a user application process of the computing unit is transparently redirected to the behavioral simulation of the network adapter, to thereby invoke a desired functional behavior.

Systems and computer program products corresponding to the above- summarized methods are also described and claimed herein.

Further, additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts a partial block diagram of a computing unit 100 to implement a behavioral simulation of a network adapter behavioral simulation (NABS), in accordance with an aspect of the present invention;

FIG. 2 graphically represents NABS memory mappings employed to simulate direct memory access, in accordance with an aspect of the present invention;

FIG. 3 depicts a state diagram of one embodiment of a behavioral simulation of a network adapter, in accordance with an aspect of the present invention;

FIGS. 4A & 4B depict a flowchart of a scheduler function for a network adapter behavioral simulation embodiment, in accordance with an aspect of the present invention;

FIGS. 5A & 5B depict a flowchart of one embodiment for initiating channel command processing within a network adapter behavioral simulation, in accordance with an aspect of the present invention;

FIG. 6 depicts a flowchart of one embodiment of write command processing for a network adapter behavioral simulation, in accordance with an aspect of the present invention;

FIGS. 7A & 7B depict a flowchart of one embodiment of external write function processing for a network adapter behavioral simulation, in accordance with an aspect of the present invention; and

FIG. 8 is a block diagram of a computing environment having multiple computing nodes in communication across a switch network, each having one or more instances of a behavioral simulation of a network adapter, in accordance with an aspect of the present invention.

### BEST MODE FOR CARRYING OUT THE INVENTION

Presented herein is a technique for simulating a network adapter for a computing unit within a distributed computing environment, which may be readily scaled to multiple instances within the computing unit or disposed across multiple computing units within the environment. The technique includes providing a behavioral simulation of the network adapter for the computing unit; and mapping the behavioral simulation to system memory of the computing unit to allow for direct memory access (DMA). The mapping is such that a network adapter function issued by a user application process of the computing unit is transparently redirected to the behavioral simulation of the network adaptor, to thereby invoke the desired functional behavior. The DMA capabilities and scalability of the approach advantageously allows for software designers to test software or to verify that software components interact as designed notwithstanding that the actual network adapter hardware is currently unavailable, for example, is still under development.

Modern network software is very complex. Usually, software is represented by multiple layers in a stack. The top layer is typically the application programming interface (API). By way of example, existing APIs on an IBM RISC System/6000 Scalable POWERparallel systems (SP) computer system, available from International Business Machines Corporation of Armonk, N.Y., include a message passing interface (MPI), a low level application programming interface (LAPI), a kernel low level application programming protocol (KLAPI) and a TCP/IP protocol stack. The MPI layer is supported by a message passing communication interface (MPCI), which implements a reliable point-to-point transport between end points. The MPCI layer is supported by a hardware abstraction layer (HAL), which is a transport talking to the network adapter. The above-mentioned layers use kernel services provided by the network adapter device driver. Similar layered structures exist for LAPI, KLAPI and TCP/IP protocols. LAPI shares HAL services with MPCI. KLAPI uses services provided by kernel HAL (KHAL), while the TCP/IP protocol stack has a pseudo device driver, traditionally called IF of its own.

As noted, proposed herein is a network adapter behavioral simulation (NABS) to be employed in place of the network adapter hardware. NABS is designed to operate functionally according to the network adapter specifications and is implemented transparent to both the user processes and the device driver. In this connection, “transparent” means that the user processes and the device driver are unaware of the existence of NABS, with the communication interface functions and interface registers provided thereby being substantially identical to the functions and interface registers of the network adapter hardware itself. Further, NABS can use existing communication interfaces, for instance a socket interface, to talk with other instances of NABS located on remote nodes in a distributed processing environment, for example, different nodes of an IBM SP System. NABS provides a virtualization of communications, with physical level communications being replaced by a software interface. For example, a new socket interface can run on top of NABS which uses an old socket interface.

Verification that all layers of a stack work as intended is a significant undertaking. The functional mappings introduced in the embodiment of NABS described herein provide a platform for rapid prototyping and full scale verification of communication protocols like MPI, LAPI, KLAPI and IP and the network adapter device driver. To discuss this in greater detail, a model of a network adapter, called Network Adapter Model Architecture (NAMA) is introduced, and how NABS simulates NAMA is explained below, as well as the functional mappings by which NABS communicates with the device driver and user processes running the protocols.

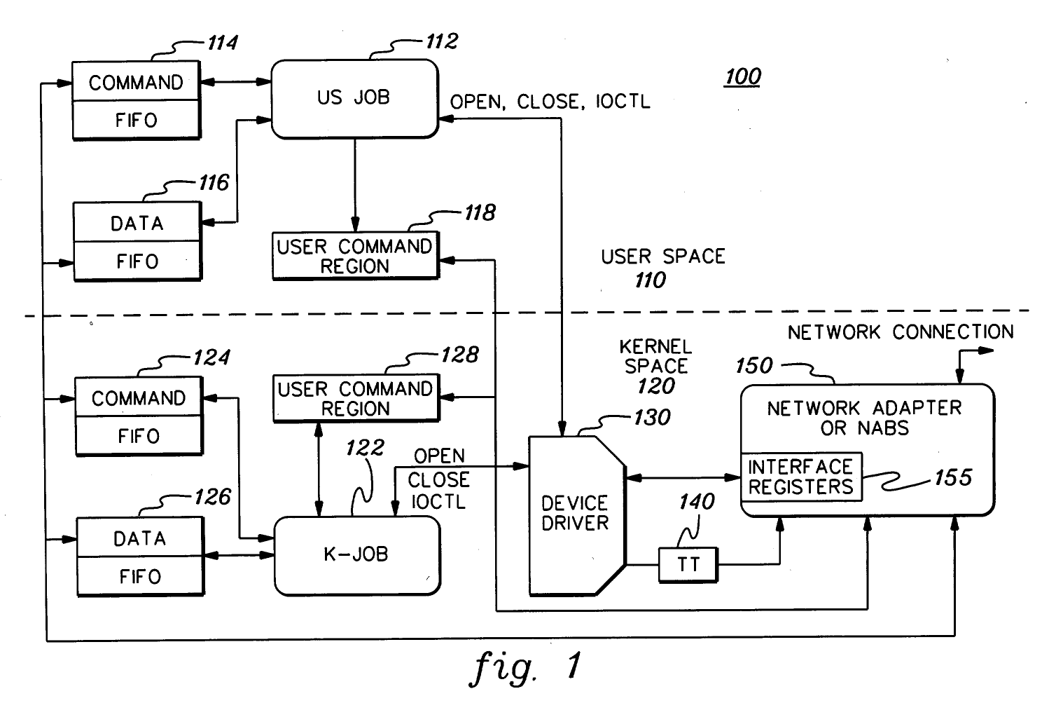

At a logical level, the hardware network adapter and NABS communicate with user processes and the device driver in the same way, as represented by FIG. 1. The underlying mechanism, or functional mappings, are different however as explained further herein.

FIG. 1 includes:

Computing unit running an instance of an operating system 100—having a user space operating environment 110 and a kernel space operating environment 120;

US Job 112—a process or job running in user space (US) 110, e.g. MPI or LAPI;

K Job 122—a kernel process or a user process running in kernel space (K) 120, e.g. KLAPI, IP pseudo device driver, or IP network device driver;

Device Driver 130—a network adapter device driver;

Command FIFO 114, 124—pinned memory regions to store channel commands;

Data FIFO 116, 126—pinned memory regions to store inbound and outbound packets;

User Command region 118, 128—memory regions mapped into user address space and kernel address space to control the adapter;

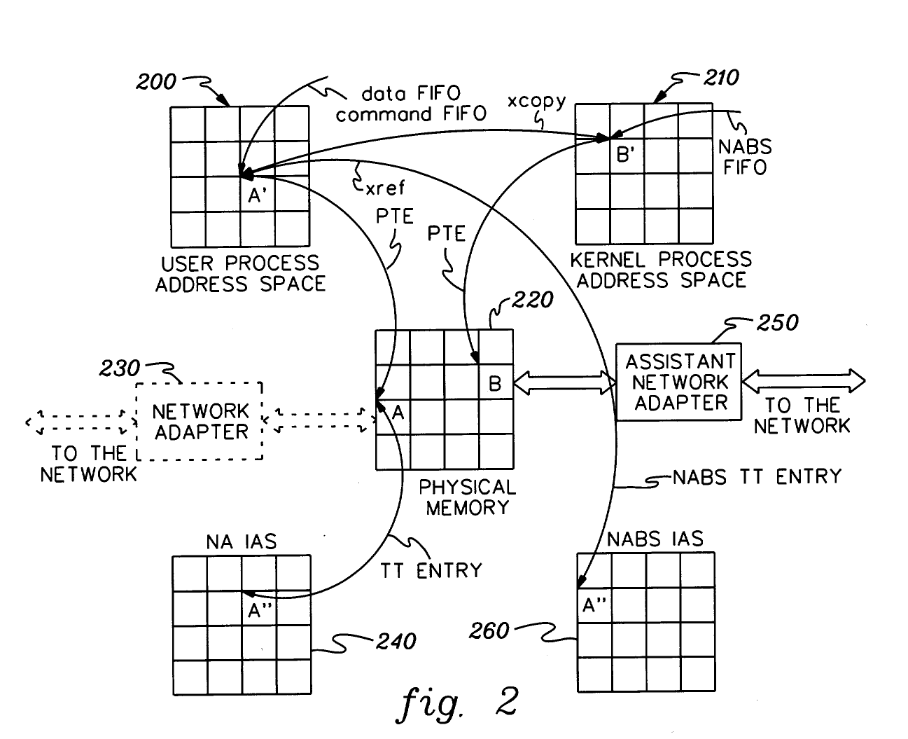

TT 140—translation tables, mapping page addresses from the Adapter Internal Address Space (AIAS) into the physical address space as explained further below with reference to FIG. 2;

Network adapter or NABS 150—hardware device or behavioral simulation thereof proving an interface between system memory and the network across a network connection;

Interface registers 155—the network adapter registers visible to the device driver.

Hardware network adapters use a Direct Memory Access (DMA) to system memory, i.e. the command FIFO and data FIFO. The user command regions 118 and 128 are hardware registers visible to software mapped into the address space of a process by the operating system services as explained herein.

NABS simulates DMA to the data and command FIFOs, as well as to the user command region, by means of a cross memory access into the process address space. This has an impact on the translation table 140 organization. Jobs communicate with the network adapter via the user command region and system memory. The jobs are allowed to write a command into the region to be processed by the network adapter. NABS simulates the user command region so that a job cannot notice the difference between the adapter hardware and NABS. The same applies to the command and data FIFOs in system memory which are accessed by NABS in a manner transparent to the job. As soon as device driver 130 implements its services, i.e. the OPEN, CLOSE and IOCTL functions for the network adapter, user jobs work with NABS the same way as they work with the actual network adapter hardware being modeled.

The device driver communicates with the hardware adapter via the interface registers. These registers are simulated by NABS, preserving the semantics of the hardware registers. The interface registers are mapped into the kernel address space, shared by the kernel processes. NABS can interrupt the device driver in the same way as the adapter hardware by calling the registered interrupt handler.

This means that with exception of the mapping adjustments and the translation table initialization differences, the device driver communicates with NABS in the same way as with the actual adapter hardware under development.

In order to achieve transparency of the behavioral simulation of the network adapter to the user processes and the device driver, the following is a list of requirements for NABS to support, in accordance with one implementation on an IBM SP distributed computer system.

support user space Communication Subsystem Components components: MPI, MPCI, LAPI and HAL

support kernel communication components: IP, KHAL, and KLAPI

support adapter device driver

provide functionality that supports testing at Unit, Integration and Functional Verification Test (FVT) of the complete communication stack including: Device Driver; HAL/KHAL; IP network interface; MPI/MPCI, LAPI/KLAPI

support concurrent use by multiple user and multiple kernel protocol stacks

support multiple adapters inside a computing unit connected to a single or multiple switch planes

support assymetrical adapter and OS configurations

debug support per simulated hardware channel

misuse of channel commands

invalid channel setup

simulate hardware interrupts

support message passing between processes both coresident on the same OS and distributed across multiple OSs and hardware nodes

As noted, the Network Adapter Model Architecture (NAMA) introduced herein is used to demonstrate NABS communication with user processes and the device driver.

NAMA can be viewed as an array of entities called channels. A channel exports an interface to US jobs and K jobs, defined above, which allows them to control execution of a channel program. A channel program is a sequence of channel commands (described below) processed by NABS. The number of channels is fixed, but not limited by the architecture. Channels operate independently of each other. Each NAMA channel exports interface structure members called registers visible to the device driver:

channel.interface.status—reflects channel status;

channel.interface.translation_table—points at the origin of the translation table in system memory;

channel.interface.user_command—points at the origin of the user command region in system memory;

channel.interface.channel_command—points at the command to be executed by the channel;

channel.interface.interrupt_control—non-fatal interrupt mask;

channel.interface.interrupt_status—reflects channel interrupt status;

channel.interface.fatal_interrupt_status—reflects channel fatal interrupt status.

All registers except for channel.interface.interrupt and channel.interface.fatal_interrupt are available for read and write.operations. Interrupt registers can be read or cleared by the device driver, but are only set by NABS. To access interface registers, the device driver uses a pointer to the channel.interface group which is part of the channel structure. The remaining members of the channel structure are for internal NABS use only.

The register channel.interface.status indicates if the channel is enabled or disabled. A disabled channel is unable to receive (send) data from (to) the network. A channel becomes disabled if NABS encounters a fatal error while processing channel commands. A channel is enabled by clearing the status register.

NAMA defines the adapter.interface group visible to the device driver and represented by the adapter.interface.interrupt_queue member, which is the head of the interrupt queue list. Each member of the list has a pointer to the channel having a pending interrupt and a pointer to the next element on the list. Interrupts are placed on the interrupt queue every time NABS detects an interrupt condition.

When the channel.interface.fatal_interrupt_status register is set, the channel aborts the operation it was performing and places the interrupt on the interrupt queue. Fatal interrupts disable the channel, i.e., channel.interface.status is set. In order for a channel to be functional again, the channel.interface.fatal_interrupt_status and channel.interface.status registers are to be cleared.

The channel.interface.interrupt_status register is set when NABS completes processing of the local channel command requesting an interrupt or when it receives a packet sent by a remote channel command requesting an interruption of the remote node after the packet is processed.

When channel.interface.interrupt_control register is cleared, non-fatal interrupts are delivered to the device driver, otherwise they remain pending. If an interrupt is pending at the time the channel.interface.interrupt_status register is cleared, the interrupt is delivered to the device driver. At most, one non-fatal interrupt per channel may appear in the interrupt queue.

To facilitate understanding of the memory mapping disclosed herein, the following definitions are provided:

Physical Memory (Real Memory)—memory treated as hardware capable to store data.

Physical Address (Real Address)—an address of a unit of information stored in physical memory.

Physical Address Space (Real Address Space)—scope of physical addresses (real addresses) that can be handled by memory controllers.

Page Address—the address of the first addressable unit of information (typically a byte) in the page.

Effective Address—a virtual address by which a unit of information can be referred from a process.

User Process—a process running in non privileged mode, called a user mode.

Kernel Process—a process running in a privileged mode, called a kernel mode.

Process—the entity created by the operating system to control an execution of a program. Depending on the operation mode a process may run in user mode or kernel mode.

Effective Page Address—the effective address of the first byte (addressable unit of information) in the page.

User Process Address Space—the scope of effective addresses available to a process running in user mode.

Kernel Process Address Space—the scope of effective addresses shared between processes running in kernel mode.

User Process Memory—the union of addressable memory units from process address space.

Kernel Process Memory—the union of addressable memory units from kernel process address space.

Adapter Internal Address Space—the scope of memory unit addresses the adapter hardware can handle.

Translation Table—the table mapping page addresses from AIAS to physical (real) page addresses.

Cross Memory Handle—a reference (pointer) to a data structure, created by the operating system, to facilitate an access to the user process address space from a kernel process.

NAMA uses Adapter Internal Address Space (AIAS) to locate channel commands and data in system memory. For hardware adapters some form of a translation table 140 (FIG. 1) is used to map AIAS to the physical address space, used by the memory controllers. Each entry in the table defines the mapping of a physical page address to AIAS. Translation tables are typically initialized by network adapter device drivers in a sequence of steps as follows:

1. device driver, kernel process or user process allocates system memory region;

2. device driver pins the memory region;

3. device driver finds physical address for each page in the memory region;

4. device driver initializes translation table entries with physical addresses.

NABS accesses system memory via the processor address translation logic. Translation tables for NABS are therefore redefined to map an effective page address to AIAS. The effective address space spans all memory regions that can be accessed from within the process. In addition to the effective address, for each translation entry a cross memory handle is allocated. Together they open an access to the process address space; that is, the cross memory handle and the effective address uniquely identify a memory region in the process address space at any instant of time. This pair mapped to an address in AIAS is a translation entry in NABS. Further information about cross memory operations can be found in an IBM publication entitled “Technical Reference: Kernel and Subsystems”, volume 1, publication number SC23-4163-00 (1997) which is hereby incorporated herein by reference in its entirety. This material describes kernel services which are available to move data between any region in the kernel address space, where NABS operates, and a (registered) region in user process address space. These services are used to simulate DMA to the user process address space.

When the device driver runs with NABS the steps to initialize the translation table are:

1. device driver or user process allocates system memory region;

2. device driver pins the region;

3. device driver finds the cross memory handle for the region;

4. device driver initializes translation table entries with translation_table structures.

AIAS may be as large as the physical address space within the actual hardware adapter, and as large as the effective address space employed by NABS.

One implementation of the memory mappings used by NABS to simulate Direct Memory Access (DMA) is shown in FIG. 2 and discussed below. FIG. 2 includes:

user process memory segment in the effective address space (EAS) 200, holding the data FIFO and command FIFO;

kernel memory segment in the effective address space 210, holding the NABS FIFO;

physical memory in the physical address space 220;

network adapter 230, simulated by NABS;

NA IAS (Network Adapter Internal Address Space) 240;

assistant network adapter 250, used to transfer packets between NABS instances running on remote nodes; and

NABS IAS (Network Adapter Behavioral Simulation Internal Address Space) 260.

Square blocks in user process memory, kernel memory, NA IAS and NABS AIAS represent address regions, known as pages.

The network adapter (simulated by NABS) is shown in a dashed box. The adapter is connected to the network and is capable of accessing pages in the physical memory. The network adapter has its own address space, which is mapped to the physical memory by a Translation Table (TT). Each valid TT entry maps a page from NA AIS to a physical page address.

This mapping is shown by the link connecting pages A and A″. When the network adapter receives a packet destined to its page A″, it locates a translation entry for A″. The entry contains the physical address for page A in physical memory. The adapter uses direct memory access to store data to the page. This data appears in the user process page A′ mapped to A via the Page Table Entry (PTE), shown by the link between pages A′ and A.

Page A is part of the data FIFO or command FIFO. The described page mappings and the DMA method allow the network adapter to access the data FIFO and the command FIFO in the user process memory.

NABS provides the same functionality via the cross memory access method, supported by the mappings shown in FIG. 2 and explained below.

NABS makes use of an “assistant adapter” which handles traffic between the network and physical memory. Any existing network adapter can be the assistant adapter. For example, the Ethernet adapter or IBM's SP Switch adapter could function as the assistant adapter. The assistant network adapter may access page B in physical memory, using the DMA method, which is mapped into the NABS address space by a PTE entry. This mapping is shown as a link between pages B and B′, with page B′ belonging to the input or output FIFO of NABS.

Like the simulated network adapter, NABS has Internal Address Space. In contrast with the network adapter, however, this address space is mapped to the user process address space, as shown by the link between pages A″ and A′.

The described mapping is defined by the cross memory access method exported by the operating system. Cross memory access allows data transfers between the registered region in user process memory and the kernel memory. This registration information is stored in NABS translation table entries.

The cross memory access method also implements a function to copy data between the kernel memory and the user process memory. This function is shown as “xcopy” in FIG. 2.

When NABS detects data in its input FIFO in page B′ destined to page A″, it finds the translation table entry for A″. This entry maps that page to A′, which contains the handle required by the operating system to access the user process address space, as well as the effective address of page A′0 in that address space. NABS then uses the xcopy function to move data from its input FIFO in page B′ to page A′.

Those skilled in the art will recognize that the described mappings, combined with the cross memory access method, simulate the DMA method of a network adapter. This is significant for building simulations of network adapters supporting large scale simulations across the network, such as proposed herein.

Continuing with the description of the interface registers, the channel.interface.translation_table register contains the (effective) address of the translation table in the kernel. The NAMA device driver allocates resources for the translation table and initializes it before the channel can be used. Translation tables may be shared between channels.

The channel.interface.user_command register points at the user command region in user process address space. The user command region is used by the process to control the channel. The user command structure is located at its origin. It has three members (registers):

user_command.start_dma;

user_command.enable_interrupt;

user_command.disable_interrupt.

Writing to the channel.user_command.start_dma register is interpreted by NABS as a command to initiate channel command processing. The other two registers are used to set or clear a mask for non-fatal interrupts. The user command region is registered with NABS before the channel is placed on the open channel list. To register the region one should provide a cross memory handle and the effective address of the region, which are saved in channel.user_command_region.cross_memory_handle and channel.interface.user_command. NABS uses the handle and the address for the cross memory access to the user command region to poll the user_command registers.

The channel.interface.channel_command register is initialized with the address from AIAS. This address is mapped to the channel program (a sequence of channel commands) located in the user process address space by the translation table. The channel.interface.channel_command register is incremented by the length of the channel command every time the channel command is processed.

NAMA is assumed to define four channel commands: write, read, jump and stop. The write channel command moves data from system memory to the network, and comprises a structure with the members:

write.op_code—the unique operation code;

write.data_address—the AIAS address of the data to be transferred to the target node;

write.count—byte count of the data to be transferred;

write.target_adapter—target adapter ID;

write.target_channel—target channel ID;

write.local_interrupt—invoke local channel non-fatal interrupt when data transfer is complete;

write.target_interrupt—invoke target channel non-fatal interrupt when data transfer is complete.

The address in system memory from which data is to be taken can be located via the translation table. The count field can be as large as the maximum packet size. Each adapter in the network is uniquely identified by its adapter ID. The completion of the operation is considered with respect to the adapter and the channel on which the operation is performed. If write.local_interrupt is set and channel.interface.interrupt_control register is cleared, the non-fatal interrupt will be placed on the interrupt queue after the packet leaves the adapter. If write.target_interrupt is set and channel.interface.interrupt_control register on the remote adapter is cleared, the non-fatal interrupt will be placed on the target adapter interrupt queue after the data is stored in system memory by the target adapter.

The read channel command moves data from the network into system memory. In one embodiment, this command has four members:

read.op_code—the unique operation code;

read.count—byte count of the data that was received;

read.data_address—the AIAS address at which the data is stored; and

read.local_interrupt—invoke non-fatal interrupt when data transfer is complete.

The address in system memory at which the data is to be stored is located via the translation table. The count field is initialized with the number of bytes received from the network.

The jump channel command is used to jump to a new location where the next channel command will be processed. In one embodiment, it is a structure with the following members:

jump.op_code—the unique operation code; and

jump.data_address—the AIAS address of the next channel command.

The stop channel command, stops channel command processing. It has a single member: the unique stop.op_code. The stop channel command can be dynamically modified by other channel commands. A write into the channel.user_command.start_dma register is required to initiate channel command processing on the send side.

Device Driver Interface Functions

To simplify the task of managing channels, NABS defines certain interface functions.

An open channel function has five arguments:

1. channel number;

2. a pointer to the initialized by the device driver channel.interface group;

3. a cross memory handle for the user command region; and

4. an effective address of the user command region;

5. a pointer to the device driver interrupt handling function.

The open channel function verifies that the channel is not allocated, and returns an error code if it is. The channel.interface group information is copied into the channel structure and the channel is placed on the open channel list. This is a circular list where each member is a pointer to the channel structure and a pointer to the next element on the list. The list is used by the NABS scheduler to process channels. The open channel function initializes the channel.state as INACTIVE. The third argument is saved in channel.user_command_region.cross_memory_handle, the fourth argument is saved in channel.interface.user_command, and the fifth in channel.interrupt_handler.

The close channel function takes a channel number as an argument. This function removes the channel from the open channel list, so that the NABS scheduler no longer processes the channel.interface group for that channel.

The reset channel function takes two arguments: a channel number and a pointer to the channel.interface.channel_command member. The channel to be reset. must be on the open list, otherwise an error is returned. This function resets the channel.state to INACTIVE, clears channel.interface.status and reinitializes the channel.interface.channel_command pointer to the value in the input argument. Further, it clears any pending fatal and non-fatal interrupts on the interrupt queue for the channel and clears interrupt status members of the channel.interace group.

NABS Operations

NABS runs as a kernel process. The NAMA device driver communicates with NABS through the device driver interface functions. Once the NABS scheduler encounters a channel on the open channel list, it starts processing the channel. After the channel is processed the scheduler switches to the next channel and so on. The NABS process has two kernel threads: one which receives packets from the network, called the IFIFO thread, and the other one which injects packets onto the network, called the main thread.

A. Channel State Machine

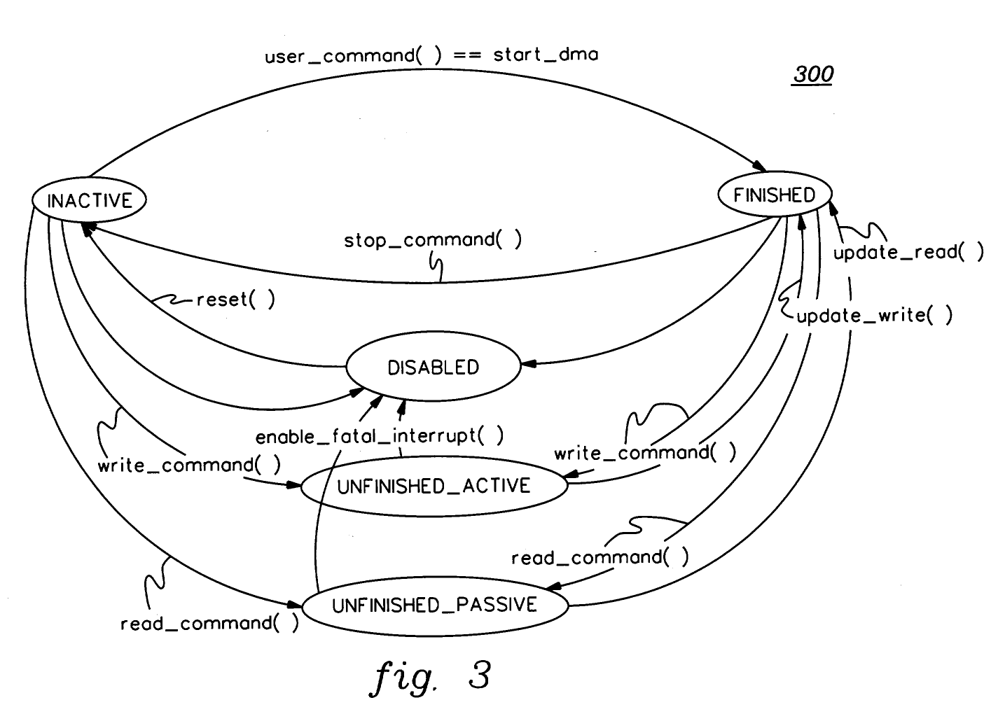

At any time instance, a channel has the channel.state variable set to a value from the list: INACTIVE, DISABLED, FINISHED, UNFINISHED_ACTIVE, or UNFINISHED_PASSIVE. Transitions between these states are shown in the state diagram 300 of FIG. 3.

The INACTIVE state is entered after the channel is placed on the open channel list and has its channel.interface.status cleared. This means that the channel either has not started channel command processing or is done with channel command processing. If channel.interface.status is set, the channel enters the DISABLED state. This happens when for some reason a fatal interrupt is enabled by the enable_fatal_interrupt function. This function is responsible for transitions to the DISABLED state. The reset function, introduced in the device driver interface section, clears channel.interface.status and returns the channel to the INACTIVE state. When the user_command function discovers that channel.user_command.start_dma is set, it returns the start_dma value. The channel leaves the INACTIVE state and enters the FINISHED state.

A user process initiates DMA by writing in the channel.user_command.start_dma register. NABS polls the user_command region for all channels on the active list by calling the user_command function and initiates channel command processing if channel.user_command.start_dma is set. Channel commands are processed as follows. NABS takes the command address from the channel.interface.channel_command register. This address is in the AIAS and is translated using the translation table pointed by the channel.interface.translation_table register. The resulting effective address is used to fetch the channel command. If this command is the write command, the channel enters the UNFINISHED_ACTIVE state. If the command is the read command, the channel enters the UNFINISHED_PASSIVE state.

In the UNFINISHED_ACTIVE state, NABS processes the command, injects the packet into the network, increments channel.interface.channel_command by the length of the write command and proceeds to the next channel command. In the UNFINISHED_PASSIVE state, the channel waits for the inbound packet, and does not finish processing the read command until the packet arrives. When the packet arrives, NABS processes the read command for the channel and calls the update_read function. The update.write function is called when the write command is processed. These functions return the channel to the FINISHED state, indicating that NABS has finished processing the channel command. The stop channel command, causes a transition from the FINISHED state to the INACTIVE state. A channel leaves the INACTIVE state when NABS detects an inbound packet destined for the channel, thereby beginning channel command processing.

The write command is illegal at this time. It will force the channel into the UNFINISHED_ACTIVE state but later, due to the command mismatch the channel will enter the DISABLED state.

As noted, the read command will force the channel into the UNFINISHED_PASSIVE state. As a result of the read command processing, data is copied from the network into the system memory pointed by the read.data_address field of the read command.

The stop command will leave the channel in the INACTIVE state, but the inbound packet will be dropped.

B. NABS Scheduler

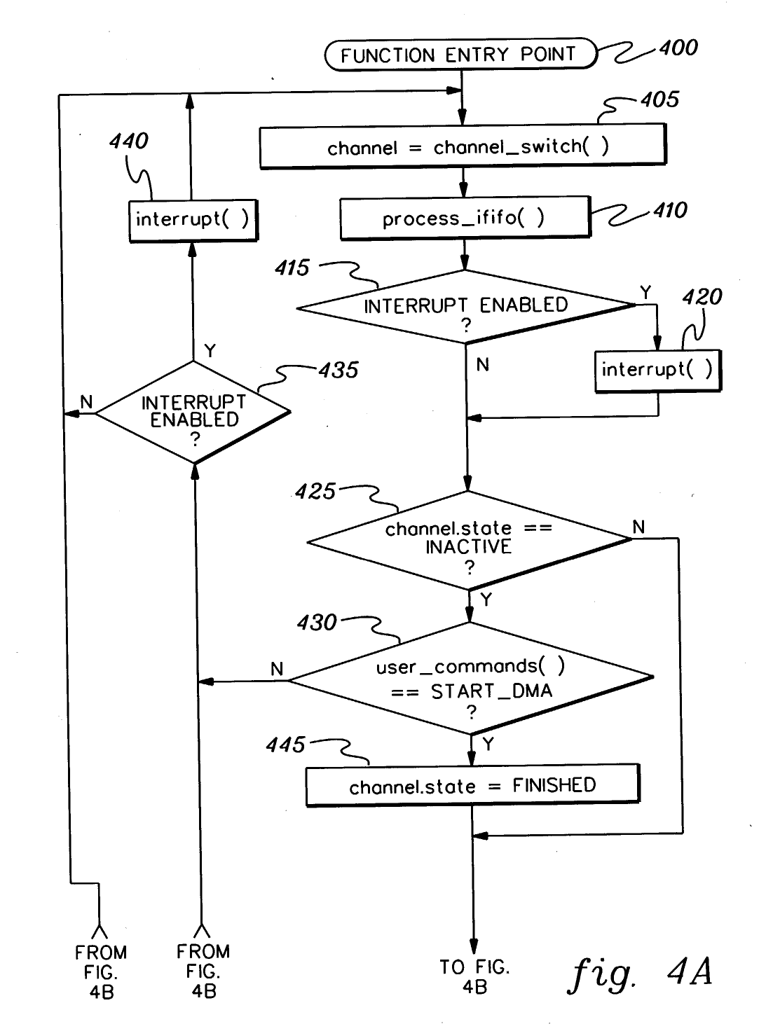

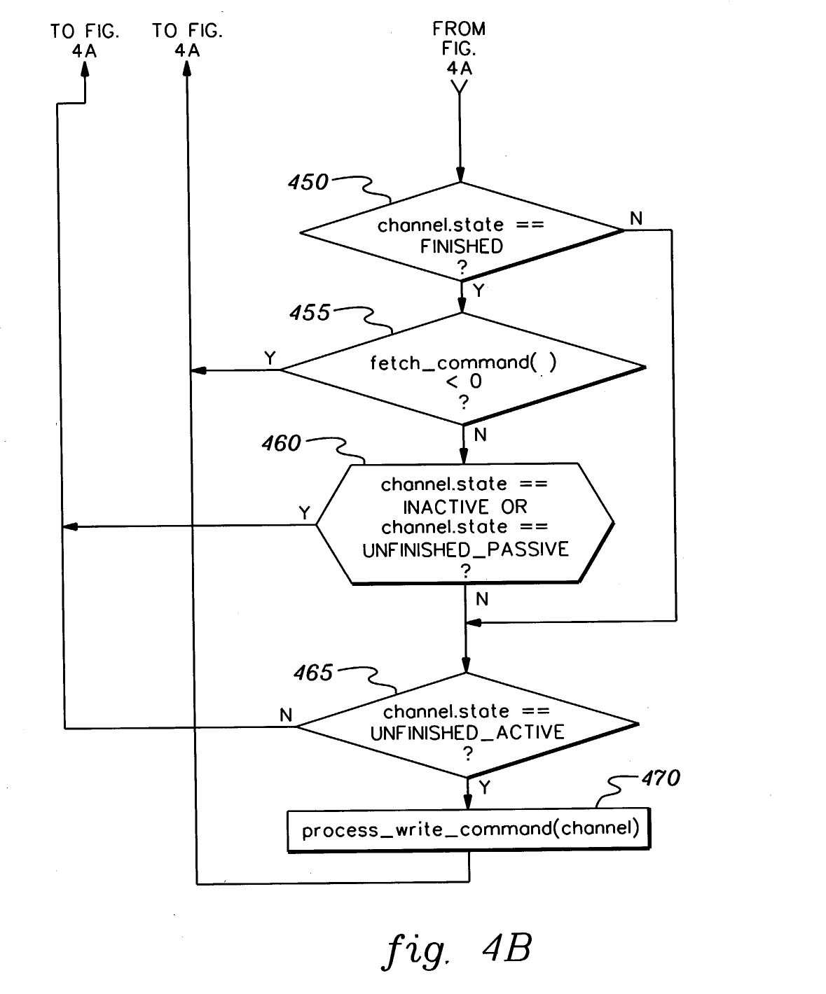

The scheduler function, shown in FIGS. 4A & 4B, is at the bottom of the programming stack. It can be traced back from any other NABS function or system function encountered while NABS is running.

The scheduler is entered 400 after NABS is configured and started. The channel_switch function implements a context switch between NAMA channels: every time this function is reentered, a new channel is picked from the open channel list 405. If no channels are opened, NABS sleeps until the list is not empty. The selected channel is assigned to the channel variable, passed as an argument to other functions. The next function called is process.ififo 410. This function checks if there are any packets in the Input FIFO (IFIFO) received by the IFIFO thread. If there are none, the function returns to the scheduler, otherwise it starts the inbound packet processing. The function is described in greater detail below. For now, it is important that as a result of that processing, interrupts may be enabled 415. The enabled interrupts are placed on the adapter interrupt queue pointed by adapter.interface.interrupt_queue. To check if an interrupt is pending, it is sufficient to check if this pointer is not at the end of the list. A non-fatal interrupt can be requested by the write command having the write.target_interrupt member set, or by the read command, having the read.local_interrupt member set. NAMA could allow both non-fatal and fatal interrupts to be pending at the same time. Non-fatal interrupts are masked if channel.interface.interrupt_control is set.

A fatal interrupt cannot be masked. The interrupt enabled predicate 415, on the diagram, verifies if there are pending fatal interrupts or unmasked non-fatal interrupts and calls the interrupt function 420 if there are. The interrupt function calls the device driver interrupt handler registered with NABS when the channel is opened with the open function.

From the device driver point of view, the interrupt handler is called by NABS at the very same moment it is called by the operating system when hardware detects an interrupt. The interrupt function is described below. If the interrupt queue is empty or its elements are masked non-fatal interrupts, the scheduler checks the channel.state variable. If channel state is INACTIVE 425, the user command function is called. This function checks if any of the members in the channel.user_command group were set by the user process 430.

If channel.user_command.enable_interrupt or channel.user_command.disable_interrupt is set by the user process or kernel process writing into the user command region 430, the scheduler sets the channel.interface.interrupt_control register accordingly. It clears the channel.user_command member. If there is an unmasked non-fatal interrupt 435, the interrupt is called 440.

If channel.user_command.start_dma is set by the user process or kernel process writing into the user command region 430, the scheduler forces the channel into the FINISHED state 445. If the channel was in the state other than INACTIVE there is no need to check for channel.user_command members as they have effect only when the channel is in the INACTIVE state. If the channel is in the FINISHED state 450 (FIG. 4B), the scheduler calls the fetch_command function 455. This function initiates channel command processing from the address pointed by channel.interface.channel_command.

If any fatal interrupts were enabled, the function returns a negative value. The jump command is processed immediately, since it is merely a transfer of control to another channel command. The stop command returns the channel to the INACTIVE state. The read command forces the channel into the UNFINISHED_PASSIVE state to await for the matching inbound packet. If the channel was forced into the INACTIVE or UNFINISHED_PASSIVE states 460, then it does not require more processing at that stage. Therefore, the scheduler branches to the channel_switch function 405. If the channel was forced to the UNFINISHED_ACTIVE state 465, it means that the write command was fetched, and the scheduler calls the process_write_command function 470, explained below.

C. fetch_command Function

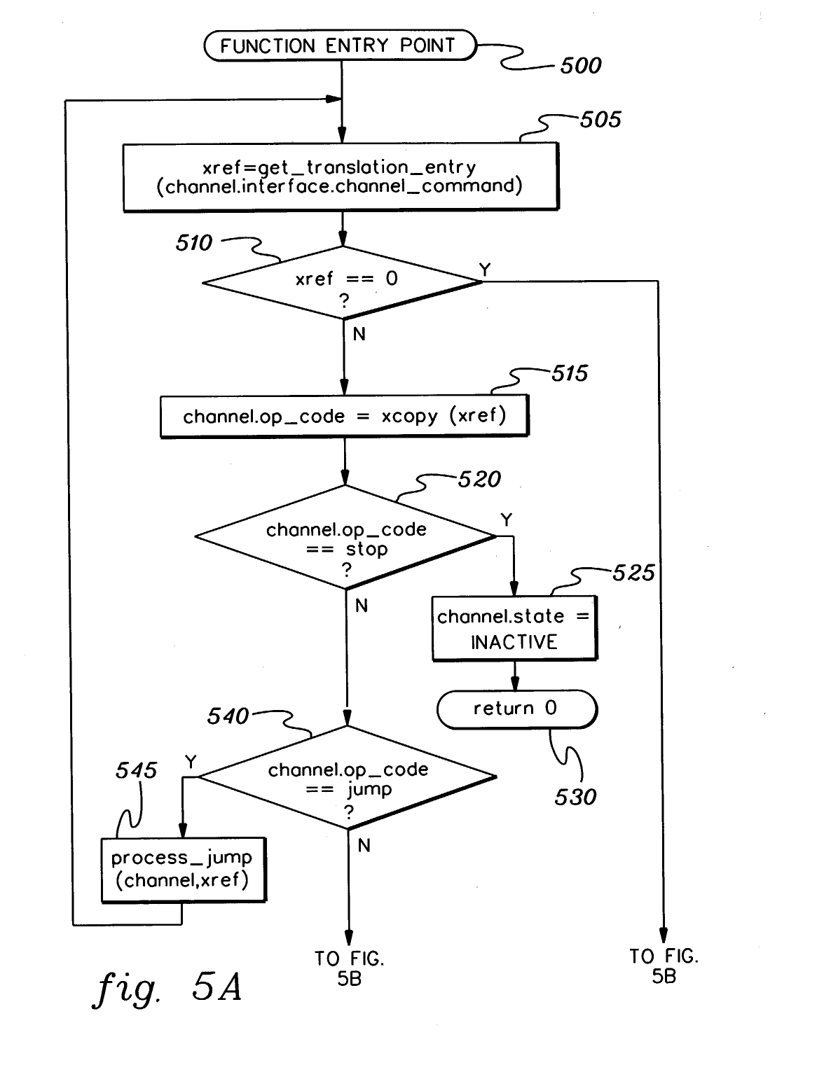

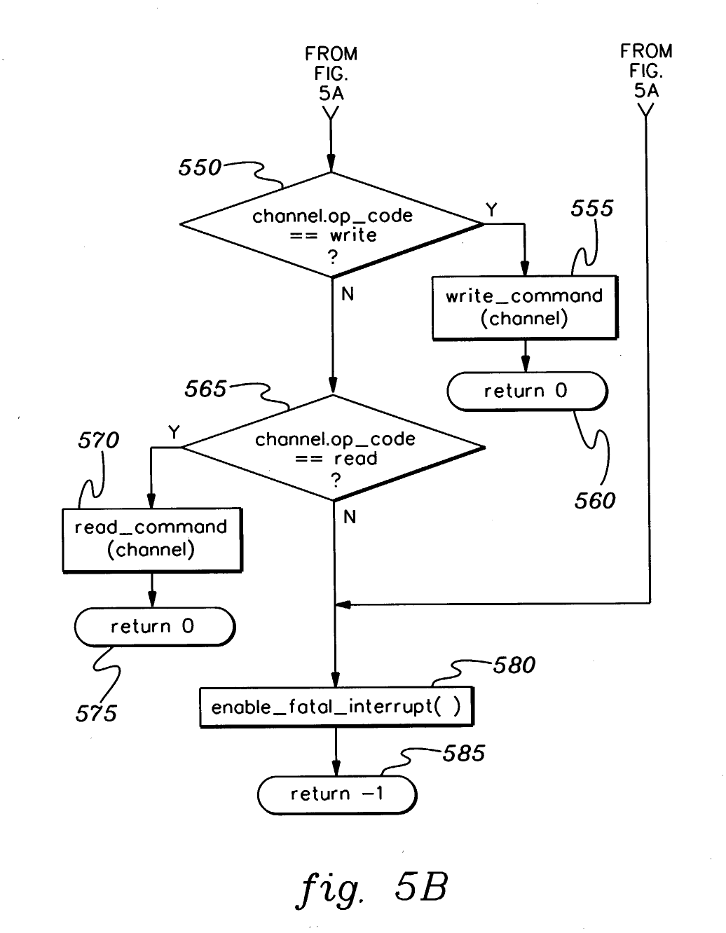

This function initiates channel command processing for all channel commands. It completes processing of the stop and jump commands. FIGS. 5A & 5B depict one example of a fetch_command function.

Upon entering this function 500, the get_translation_entry function returns a pointer to the translation table entry for the AIAS address, channel.interface.chanel_command. A translation table entry is pointed by the channel.interface.translation_table member. A pointer is assigned to the xref variable 505. A null pointer indicates that an entry cannot be found 510. The xcopy function is exported by the kernel. It uses xref to access a region of user process memory and to copy the channel command operation code into the kernel 515.

The operation code is examined 520. If it is the stop command, channel.state is forced into the INACTIVE state 525, as specified on the state transition diagram, and 0 is returned 530.

If this is a jump command 540, then the process_jump function is called 545. This function copies the entire channel command into the kernel space using the xcopy system function with the xref pointer passed as an argument. The jump.data_address address from the channel command is assigned to the channel.interface.channel_command, a pointer to the next channel command to process. The jump command is processed within the fetch_command function.

If this is a write command 550 (see FIG. 5B), then the write_command function is called 555. It copies the channel command to the channel structure member channel.write, sets the channel.state to UNFINISHED_ACTIVE, and returns 0 560.

If this is a read command 565, then the read_command function is called 570. It copies the channel command to the channel structure member channel.read, sets the channel.state to UNFINISHED_PASSIVE, and returns 0 575. Otherwise, an unknown operation code causes NABS to enable fatal interrupt 580 and a −1 is returned 585.

D. process_write_command Function

The process_write_command function builds a packet and injects it into the network. It takes two arguments: a pointer to the channel structure and a pointer to the External Routing Table (ERT).

Each ERT entry maps the destination adapter ID, stored in the write.target_adapter register, to the pair: IP address and port number of the remote adapter on the node where another NABS instance is running. The ERT table is initialized at configuration time.

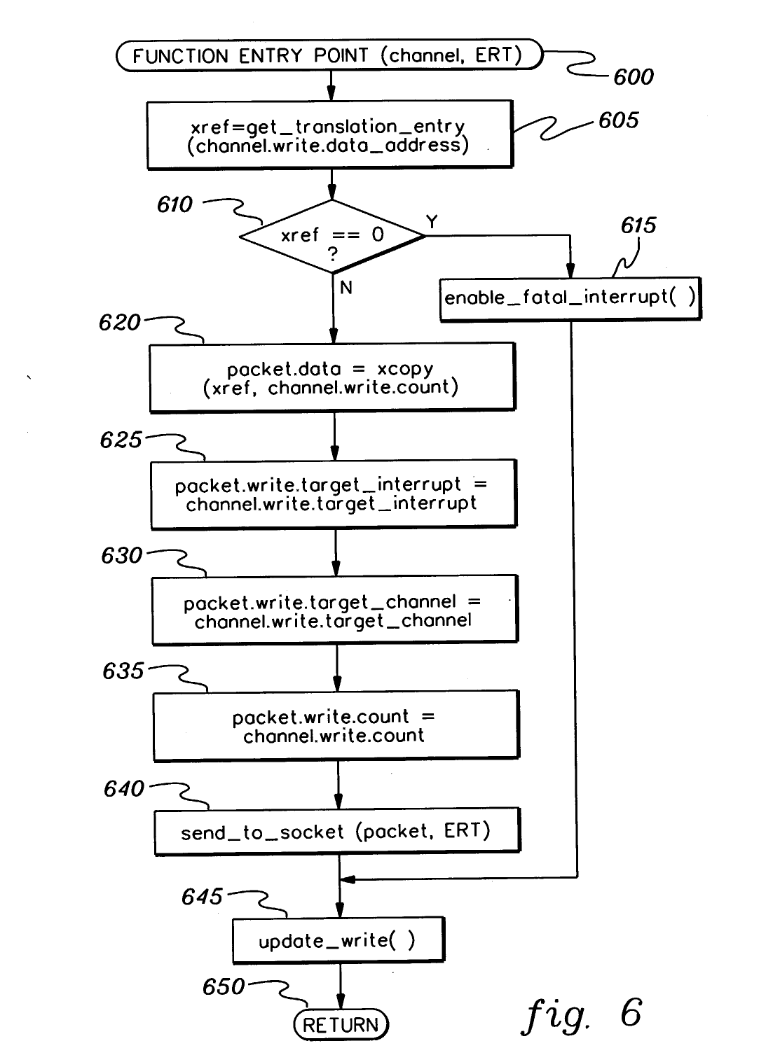

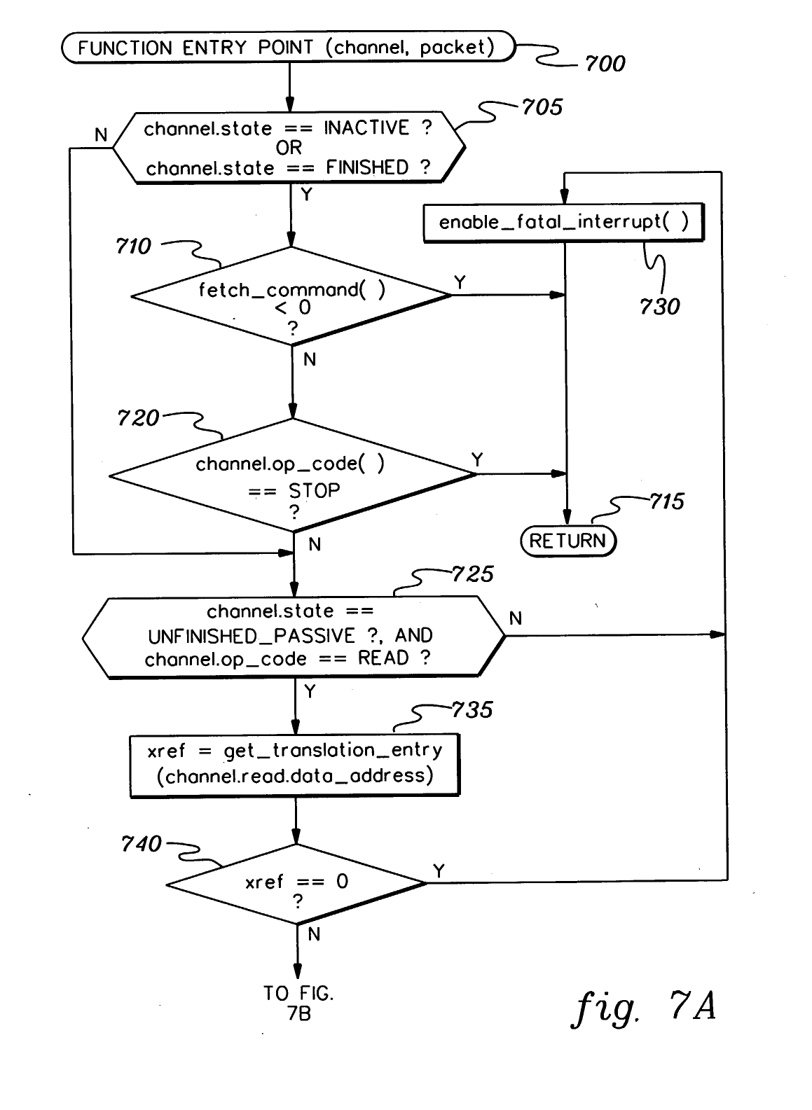

The number of NABS instances in the simulated network is only limited by the number of nodes in the network or by the size of the write.target_channel field. One embodiment of the process_write_command function is shown FIG. 6.

Once entered 600, this function finds the cross memory handle and the effective address of the data in process memory by calling the get_translation_entry function 605. The argument, channel.write.data_address, is the AIAS address of the data. As noted above, the channel command is saved in the channel structure by the write_command function called from the fetch_command function. Determination is then made whether xref is 0 610. If so, a fatal interrupt is enabled 615.

Next, the channel.write.count bytes of data is copied from user process address space into packet.data 620. The packet.write.target_interrupt is set to channel.write.target_interrupt 625, the packet.write.target_channel is set to channel.write.target_channel 630, and channel.write.count is copied to packet.write.count 635.

The send_to_socket function 640 uses the ERT pointer and the channel.write.target_adapter to locate the destination IP address and port number of the NABS instance running on the remote node and send the packet using IP sockets as a UDP (User Datagram Protocol) datagram. An update_write ( ) function is called 645 before returning 650.

If channel.write.local_interrupt is set, then the enable_non_fatal_interrupt function puts the interrupt on the interrupt queue pointed by adapter.interface.interrupt_queue. The interrupt handling function is subsequently called by the scheduler.

E. process_ififo Function

The process_ififo function runs as the main thread. Concurrently running IFIFO thread receives inbound packets into the input FIFO slots. If there are no free slots, then a packet is dropped. The process_ififo function processes the oldest packet in the IFIFO. As soon as the packet is processed, the slot can be reused. The locking kernel service is used to synchronize an access to the shared data between the IFIFO and the main thread.

When the process_ififo function detects a packet available for processing, it locates the target channel structure pointer using the channel number passed in packet.write.target_channel. It checks if the channel is in the disabled state. If it is, the function releases the slot and returns; otherwise, it calls the external_write function, which does the inbound packet processing, then releases the slot.

F. external_write Function

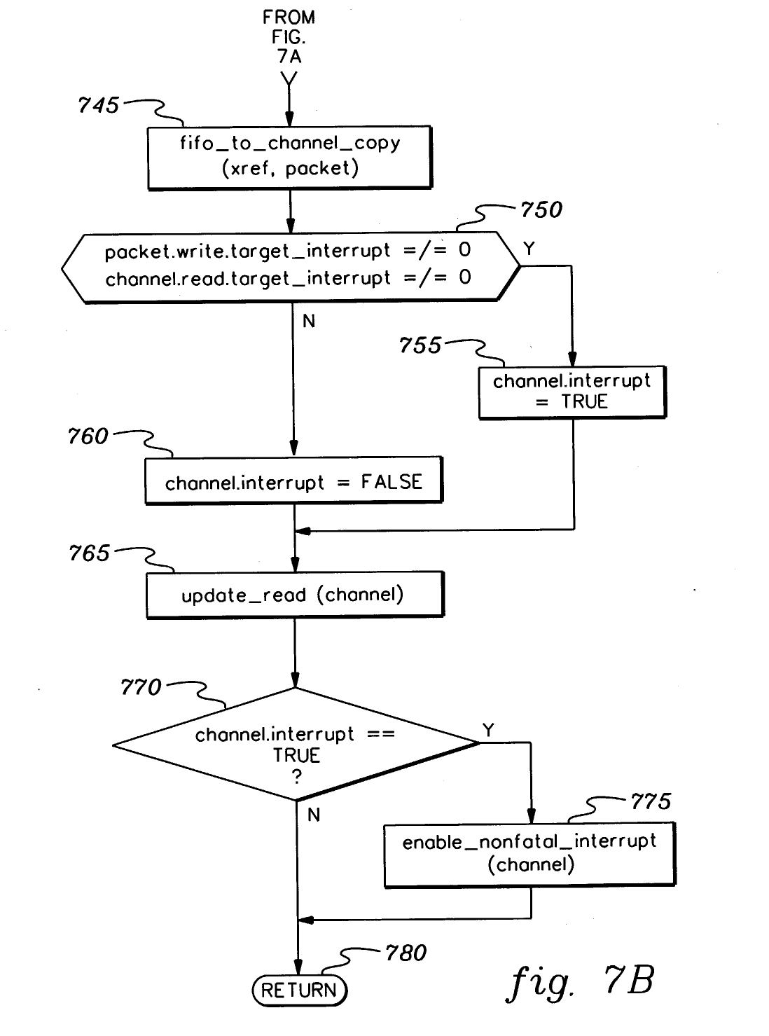

One embodiment of the external_write function is shown in FIGS. 7A & 7B.

This function possesses two arguments: a pointer to the channel structure and a pointer to the packet structure.

Once entered 700, processing determines if the channel is in the INACTIVE or FINISHED state 705, which means that the channel is either at the beginning of a channel program or at the stop channel command.

The fetch.command function begins channel command processing 710. If the function returns a negative value, it means that a fatal error was encountered and processing returns 715 to point of call.

If it is the stop command 720, packet processing is terminated 715, with the packet being ignored.

Continuing with the main flow, the expected operation code, saved in channel.op_code, must be for the read command, and the expected channel.state is UNFINISHED_PASSIVE 725. Otherwise, the target channel state is inconsistent with the read command and a fatal interrupt is enabled for the channel 730. Each write command issued by the originator channel must be matched with the read command on the target channel.

When the target channel, at the time the external_write function is entered, is neither in the INACTIVE nor FINISHED state, it means that the channel command has been prefeteched, therefore, the fetch_command function is skipped.

If the target channel command is read, the function locates the pointer to the translation table entry, xref, for the memory region in user process address space 735. If the translation entry is invalid 740, a null pointer is returned and the fatal interrupt is enabled 730.

A fifo_to_channel_copy function passes the xref pointer and the pointer to the packet structure 745 (FIG. 7B). The packet.data points at the data (payload) in the packet. The packet.write.count is the number of bytes in the payload. The function copies data from the packet to the user process memory.

If interrupts are requested by the write command, the packet.write.target_interrupt is set, while if interrupts are requested by the read command, the channel.read.target_interrupt is set 750. In either case, the channel.interrupt is set 755, otherwise it is false 760.

The update read function finishes the read channel command processing. It forces the channel into the FINISHED state 765.

If channel.interrupt has been set 770, the non-fatal interrupt is enabled with the enable_non_fatal_interrupt function 775, before returning 780. The function adds a new element to the global interrupt queue pointed by adapter.interface.interrupt_queue.

G. Update_read and Update_write Functions

The update_read function stores the packet.write.count in the read.count member of the read command pointed by channel.interface.channel_command. The channel.interface.channel_command is incremented by the length of the read command. The channel is forced into the finished state.

The update_write function increments channel.interface.channel_command by the length of the write command and forces the channel into the finished state.

H. Interrupt Function

The interrupt function processes elements on the interrupt queue pointed by adapter.interface.interrupt_queue. The elements are put on the queue by the enable_non_fatal_interrupt and enable_fatal_interrupt functions. There is at most one element per channel.

For each element, the interrupt function invokes the device driver handler, channel.interrupt_handler, saved at the time the channel was opened by the device driver. The device driver examines the interrupt and processes it. If this is a fatal interrupt, the channel is reset with the exported reset function. If it is a non-fatal interrupt, the channel.interface.interrupt_status register is cleared.

Channel command processing is suspended while the interrupt handler is running. Simulation resumes on return from the interrupt handler with an interrupt element removed from the interrupt queue.

Those skilled in the art will recognize from the above discussion that NABS can be employed to implement functional mappings of the system memory, user command region and interface registers in a manner transparent to user processes, and so that no program code modifications are required to run with NABS or the actual hardware adapter. There is no limit on the number of NABS instances which can talk to each other. Therefore, NABS provides a scalable platform for rapid prototyping and verification of the communication protocols and device driver.

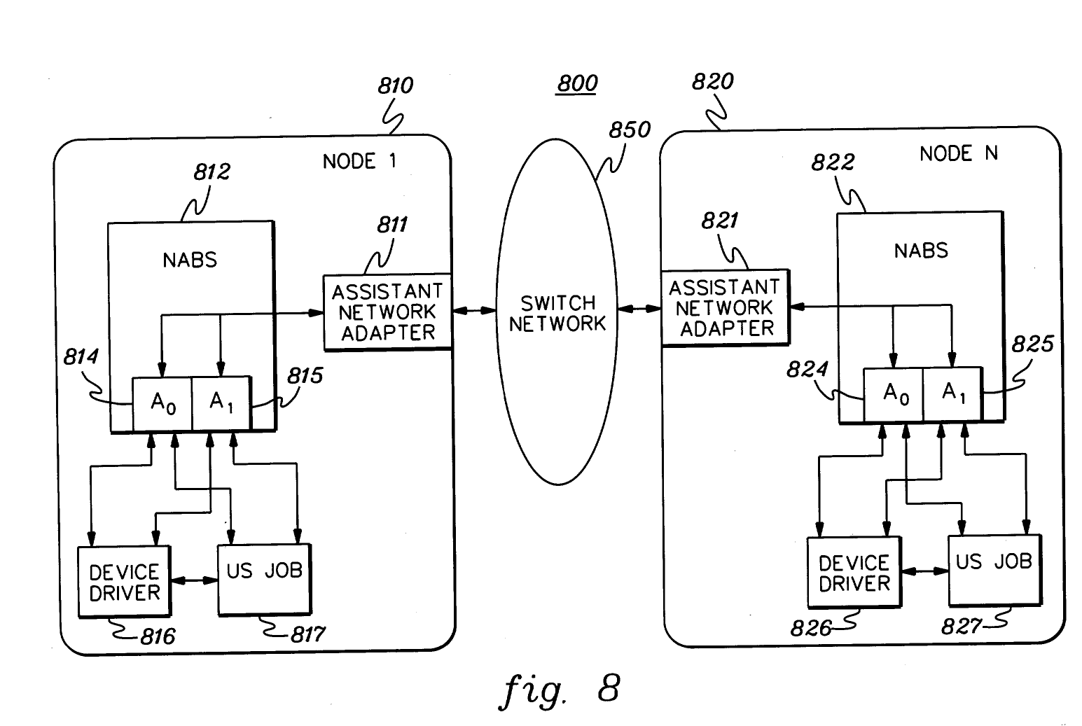

FIG. 8 depicts one embodiment of a distributed computing environment, generally denoted 800, having multiple nodes 810, 820 which communicate via assistant network adapters 811, 821 across a switch network 850. Each node implements a behavioral simulation 812, 822 such as described herein. More particularly, node 810 includes a first behavioral simulation instance of a network adapter 814, and a second simulation instance of a network adapter 815 which communicate with device driver 816 and user space jobs 817. Similarly, node N 820 employs a first behavioral simulation instance 824 of a network adapter and a second behavioral simulation instance of a network adapter 825, which similarly communicate with a device driver 826 and user space jobs 827. Each node 810 & 820 could comprise an IBM RISC System/6000 SP system running AIX, a UNIX based operating system. This example could scale up to thousands of interconnected nodes or servers, all or some of which could employ one or more adapters simulated using a NABS instance. The assistant network adapters 811, 821 could comprise any existing network adapter, which is the lowest level hardware employed by the behavioral simulation to effectuate transfer of data to and from the network.

To summarize, provided herein is a network adapter behavioral simulation which is a tool designed to support full scale software simulations on as many nodes as required. NABS provides a platform for software development and function verification testing in order to shorten the development cycle and validate the correctness of a new protocol stack, notwithstanding current unavailability of the network adapter hardware below the stack. NABS implements an identical network adapter interface, visible to user processes, and provides a scalable environment for development of communication subsystems and application protocols. NABS is capable of simulating an unlimited number of adapters connected to the same or different switch planes on a single computing unit or different computing units in a network. This allows the NABS architecture to run a parallel job, which can be important for validating a protocol stack with a complex communication pattern implemented at an application level, such as the MPI programs referenced above. In addition, NABS can be used to develop the adapter device driver and communication library that is part of a user job.

The present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A method for simulating a network adapter comprising:
providing a behavioral simulation of a network adapter for a computing unit of a computing environment; and
mapping the behavioral simulation to system memory of the computing unit to allow for direct memory access, said mapping being such that a network adapter function issued by a user application process of the computing unit is transparently redirected to the behavioral simulation of the network adapter, to thereby invoke a desired functional behavior, wherein the user application process is unaware of the absence of the network adapter.

2. The method of claim 1, wherein the behavioral simulation runs in kernel space of the computing unit and interfaces with a device driver of the computing unit while simulating network adapter functions, and wherein the device driver is unaware of the absence of the network adapter.

3. The method of claim 1, wherein the network adapter comprises a first network adapter, and the method further includes employing a second, assistant network adapter for connecting the behavioral simulation of the first network adapter to a network of the computing environment, wherein the second, assistant network adapter is transparent to the user application process via the behavioral simulation of the first network adapter.

4. The method of claim 1, wherein the providing of the behavioral simulation comprises providing multiple instances of the behavioral simulation of the network adapter for the computing unit of the computing environment, and wherein the multiple behavioral simulation instances share information through a virtualization of communications therebetween.

5. The method of claim 4, wherein the multiple behavioral simulation instances communicate by sharing information within kernel space of the computing unit.

6. The method of claim 1, wherein the providing of the behavioral simulation comprises providing multiple instances of the behavioral simulation of the network adapter for multiple computing units of the computing environment, wherein different behavioral simulations of the network adapter facilitate exchange of data between their respective computing units across a network of the computing environment.

7. The method of claim 1, further comprising employing the behavioral simulation of the network adapter to facilitate development and functional verification testing of the user application process without requiring any modification to the user application process.

8. A system for simulating a network adapter comprising:
a behavioral simulation of a network adapter for a computing unit of a computing environment; and
means for mapping the behavioral simulation to system memory of the computing unit to allow for direct memory access, the mapping being such that a network adapter function issued by a user application process of the computing unit is transparently redirected to the behavioral simulation of the network adapter, to thereby invoke a desired functional behavior, wherein the user application process is unaware of the absence of the network adapter.

9. The system of claim 8, wherein the behavioral simulation runs in kernel space of the computing unit and interfaces with a device driver of the computing unit while simulating network adapter functions, and wherein the device driver is unaware of the absence of the network adapter.

10. The system of claim 8, wherein the network adapter comprises a first network adapter, and the system further includes means for employing a second, assistant network adapter for connecting the behavioral simulation of the first network adapter to a network of the computing environment, wherein the second, assistant network adapter is transparent to the user application process via the behavioral simulation of the first network adapter.

11. The system of claim 8, wherein the behavioral simulation comprises a first instance of multiple instances of behavioral simulation of the network adapter for the computing unit of the computing environment, and wherein the multiple behavioral simulation instances share information through a virtualization of communications therebetween.

12. The system of claim 11, wherein the multiple behavioral simulation instances communicate by sharing information within kernel space of the computing unit.

13. The system of claim 8, wherein the behavioral simulation comprises a first instance of the behavioral simulation of multiple instances of behavioral simulation of the network adapter, said multiple instances of behavioral simulation being disposed on multiple computing units of the computing environment, wherein different behavioral simulation instances of the network adapter facilitate exchange of data between their respective computing units across a network of the computing environment.

14. The system of claim 8, further comprising means for employing the behavioral simulation of the network adapter to facilitate development and functional verification testing of the user application process without requiring modification to the user application process.

15. At least one program storage device, readable by a machine, tangibly embodying at least one program of instructions executable by the machine to perform a method for simulating a network adapter, said method comprising:
providing a behavioral simulation of a network adapter for a computing unit of a computing environment; and
mapping the behavioral simulation to system memory of the computing unit to allow for direct memory access, said mapping being such that a network adapter function issued by a user application process of the computing unit is transparently redirected to the behavioral simulation of the network adapter, to thereby invoke the desired behavior, wherein the user application process is unaware of the absence of the network adapter.

16. The at least one program storage device of claim 15, wherein the behavioral simulation runs in kernel space of the computing unit and interfaces with a device driver of the computing unit while simulating network adapter functions, and wherein the device driver is unaware of the absence of the network adapter.

17. The at least one program storage device of claim 15, wherein the network adapter comprises a first network adapter, and the method further includes employing a second, assistant network adapter for connecting the behavioral simulation of the first network adapter to a network of the computing environment, wherein the second, assistant network adapter is transparent to the user application process via the behavioral simulation of the first network adapter.

18. The at least one program storage device of claim 15, wherein the providing of the behavioral simulation comprises providing multiple instances of the behavioral simulation of the network adapter for the computing unit of the computing environment, and wherein the multiple behavioral simulation instances share information through a virtualization of communications therebetween.

19. The at least one program storage device of claim 18, wherein the multiple behavioral simulation instances communicate by sharing information within kernel space of the computing unit.

20. The at least one program storage device of claim 15, wherein the providing of the behavioral simulation comprises providing multiple instances of the behavioral simulation of the network adapter for multiple computing units of the computing environment, wherein different behavioral simulations of the network adapter facilitate exchange of data between their respective computing units across a network of the computing environment.
